(19) United States
(12) Patent Application Publication
(10) Pub. No.: US 2013/0171386 A1
(43) Pub. Date: Jul. 4, 2013

(54) Multi-Layer Films and Articles Made Therefrom

(71) Applicant: ExxonMobil Oil Corporation, Baytown, TX (US)

(72) Inventors: Benoit Ambroise, Hachy (BE); Jay K.M. Keung, Humble, TX (US); Pang-Chia Lu, Pittsford, NY (US)

(73) Assignee: ExxonMobil Oil Corporation, Baytown, TX (US)

(21) Appl. No.: 13/774,210

(22) Filed: Feb. 22, 2013

Related U.S. Application Data
(62) Division of application No. 11/248,838, filed on Oct. 12, 2005.

(51) Int. Cl. B32B 27/32

(52) U.S. Cl. CPC B32B 27/32
USPC 428/35.2; 428/523

(57) ABSTRACT

Multi-layer films particularly suited for packaging applications, including a core layer, a tie layer made from at least 10 wt % of a first polymer and where the first polymer preferably is not present in the core layer are provided. Optionally, the multi-layer film may have a skin layer, a second tie layer and/or a second skin layer. Embodiments may have the advantage of improved seal strength, hermeticity, hot tack and reduced-temperature sealability.

### CROSS-REFERENCE TO RELATED APPLICATION

The present application for patent is a Divisional of, and claims priority to, U.S. Ser. No. 11/248,838, filed Oct. 12, 2005, which is incorporated herein by reference.

### FIELD OF THE INVENTION

This invention relates generally to heat-sealable, multi-layer films. More specifically, this invention relates to multi-layer films with improved sealing properties.

### BACKGROUND OF THE INVENTION

Polypropylene-based multi-layer films are widely used in packaging applications, such as pouches for dry food mixes, pet foods, snack foods, and seeds. Such multi-layer films must have the ability to form reliable hermetic seals at relatively low temperatures. In some instances, the film must do so in the presence of contamination in the seal region from the contents of the pouches.

U.S. Pat. No. 6,624,247 B1 to Kume et al. (Sumitomo Chemical Company, Ltd.) discloses a polypropylene-based film of a resin composition (C) comprising: 40 to 95 weight percent of a propylene-based copolymer (A) and 5 to 60 weight percent of a polypropylene-ethylene and/or alpha-olefin block copolymer (B) having a xylene soluble component (“CXS”) of 5.0 weight percent or more, wherein the CXS has a content of ethylene and/or the alpha-olefin of 14 to 35 molar percent and wherein the heat-seal temperature of the film of the composition (C) is lower by 3° C. or more than those of respective films of the compositions (A) or (B).

U.S. Pat. No. 6,641,913 B1 to Hanyu et al. (Fina Technology, Inc.) discloses a multi-layer polyolefin film of the type suitable for packaging applications in which heat seals are formed. The multi-layer film comprises a substrate layer formed of a crystalline thermoplastic polymer having an interface surface. A heat-sealable surface layer is bonded to the interface surface of the substrate layer and is formed of a syndiotactic propylene polymer effective to produce a heat seal with itself at a sealing temperature of less than 110° C. The multi-layer film may be biaxially-oriented. In the production of the multi-layer film, a crystalline thermoplastic polymer is extruded and formed into a substrate layer film. A second polymer comprising a syndiotactic propylene polymer that is effective to form a heat-sealable surface layer is extruded separately to form a surface layer that is thereafter bonded to the interface of the substrate layer at a temperature within the range of 150° C. to 260° C.

U.S. Pat. No. 6,534,137 B1 to Vadhar (Cryovac, Inc.) discloses a two-component laminated multi-layer film suitable for use in packaging articles, such as pet food, comprising a first component and a non-heat-shrinkable second component. The first component comprises an outer first film layer, an optional second film layer, and an optional third film layer. The first and third film layers comprise ethylene/alpha-olefin copolymer, while the second film layer is a modified ethylene copolymer. The second component comprises an outer fourth layer, an oxygen barrier fifth layer, sixth and seventh layers that serve as tie layers and are positioned on either side of the barrier layer. The multi-layer film is heat sealable to itself and another film.

U.S. Pat. No. 6,794,021 B2 to Bader (ExxonMobil Oil Corporation) discloses a thermoplastic multi-layer film for forming hermetic seals on packages comprising layer A comprising polyethylene, layer B comprising polypropylene, layer C comprising a copolymer, and an adhesion promoting coating applied to layer C and a method of improving multi-layer films whereby hermetic seals can be simply and efficiently formed and whereby excellent seat characteristics are achieved.

U.S. Pat. No. 5,888,648 X6 to Donovan et al. (Mobil Oil Corporation) discloses a multi-layer film that has an improved composite structure for providing hermetic seals to packages manufactured in a high speed packaging apparatus. The structure of the multi-layer film includes a main substrate and a sealant layer. The sealant layer, in turn, includes an intermediate layer that has the primary function of compliance during sealing and a sealing layer that has the primary function of providing adhesivity to the completed seal.

U.S. Pat. No. 6,326,068 B1 to Kong et al. (Mobil Oil Corporation) discloses a multi-layer film that has an improved composite structure for providing hermetic seals to packages manufactured in a high speed packaging apparatus. The structure of the multi-layer film includes layers A/B/C/D. Skin layer A is formed from polypropylene copolymer with melt flow rate greater than one or linear high density polyethylene with melt index greater than one. Core layer B is formed from polypropylene. Intermediate layer C has the primary function of compliance during sealing, and sealing layer D has the primary function of providing adhesivity to the completed seal. The sealing layer D includes an anti-blocking agent comprising non-distortable organic polymer particles having an average particle size greater than 6 microns.

Related U.S. Application US 2002-0164470 A1 to Bader, discloses a core layer B that comprises a softening additive blended in a core layer to improve the hermeticity of a sealed package. The softening additive enhances compliance of the core layer with the sealable layer while the seal area is heated under pressure within the crimp jaws during sealing operations. The invention of the '470 application functions during sealing operations to effect a more hermetic seal. The term “compliance” as used in the '470 application is related to non-elastic, deformation or conformance within the sealing jaws during sealing operations due to the improved flowability of the core during heated sealing operation and does not refer to post-sealing seal strength and post-sealing seal performance. It is possible to improve hermeticity as per the '470 application without necessarily, substantially improving minimum seal strength.

U.S. Pat. No. 6,927,258 B2 and U.S. Pat. No. 6,982,310 to Datta, et al. (ExxonMobil Chemical Company) disclose improved thermoplastic polymer blend compositions comprising an isotactic polypropylene component and an alpha-olefin and propylene copolymer component, said copolymer comprising crystallizable alpha-olefin sequences. In a preferred embodiment, improved thermoplastic polymer blends are provided comprising from about 35% to about 85% isotactic polypropylene and from about 30% to about 70% of an ethylene and propylene copolymer, wherein said copolymer comprises isotactically crystallizable propylene sequences and is predominately propylene. The resulting blends manifest unexpected compatibility characteristics, increased tensile strength, and improved process characteristics, e.g., a single melting point.

None of the films described above combine desired improvements in seal strength, hermeticity, hot tack and sufficiently reduced seal temperatures for some of today's challenging packaging operations. Opportunities exist for polymer films to replace other packaging substrates, such as paper and foil, in many temperature-sensitive packaging operations, such as with ice cream bars, chocolate bars, and dry-particulate foods. The present invention meets these and other needs.

### SUMMARY OF THE INVENTION

The present invention generally relates to multi-layer films comprising a core layer and a tie layer, the tie layer having at least 10 wt % of a first polymer having a density in the range of 0.850 g/cm³ to 0.920 g/cm³, a Differential Scanning calorimetry (DSC) melting point in the range of 40° C. to 160° C., and a melt flow rate (MFR) in the range of 2 dg/min. to 100 dg/min. Preferably, the core layer is substantially free of the first polymer.

In another embodiment, the invention generally relates to multi-layer films comprising a core layer, a skin layer, and a tie layer intermediate the core layer and the skin layer, the tie layer having at least 10 wt % of a first polymer comprising from about 75 wt % to about 96 wt % propylene and from about 4 wt % to about 25 wt % ethylene, the first polymer having a density in the range of 0.850 g/cm³ to about 0.900 g/cm³.

In yet another embodiment, the invention generally relates to multi-layer films comprising a core layer, a skin layer, and a tie layer intermediate the core layer and the skin layer, the tie layer having at least 10 wt % of a first polymer having a flexural modulus of not more than 2100 MPa and an elongation of at least 300%.

In still another embodiment, the invention generally relates to multi-layer films comprising a core layer and a tie layer, the tie layer having at least 10 wt % of a first polymer, the first polymer having isotactic stereoregularity and comprising from about 84 wt % to about 93 wt % propylene, from about 7 wt % to about 16 wt % ethylene, and the first polymer having a DSC melting point in the range of from about 42° C. to about 85° C., a heat of fusion less than 75 J/g, crystallinity from about 2% to about 65%, and a molecular weight distribution from about 2.0 to about 3.2.

Some embodiments of the invention generally relate to multi-layer films comprising a core layer and a tie layer, the tie layer having at least 10 wt % of a first polymer made from a polymer blend comprising at least one polymer (A) and at least one polymer (B), polymer (A) comprising from about 60 wt % to about 98 wt % of the blend, and polymer (A) comprising from about 82 wt % to about 93 wt % of units derived from propylene and from about 7 wt % to about 18 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

Additionally, some embodiments of the invention generally relate to multi-layer films comprising a core layer and a tie layer, the tie layer having at least 10 wt % of a first polymer made from a polymer blend comprising at least one polymer (A) and at least one polymer (B), polymer (A) comprising from about 60 wt % to about 98 wt % of the blend, and polymer (A) comprising from about 65 wt % to about 96 wt % of units derived from propylene and from about 4 wt % to about 35 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

In another embodiment, the invention generally relates to a method of preparing a multi-layer film, the method comprising the steps of: forming a co-extruded, multi-layer film wherein the film comprises a core layer, a skin layer, and a tie layer intermediate the core layer and the skin layer, the tie layer having at least 10 wt % of a first polymer having a density in the range of 0.850 g/cm³ to 0.900 g/cm³, a DSC melting point in the range of 40° C. to 160° C., and MFR in the range of 2 dg/min. to 100 dg/min., the core layer being substantially free of the first polymer; and orienting the multi-layer film in at least one direction.

In some embodiments, the invention generally relates to a multi-layer film comprising a core layer and a tie layer, the tie layer having at least 10 wt % of a first polymer having a density in the range of 0.850 g/cm³ to 0.920 g/cm³, a DSC melting point in the range of 40° C. to 160° C., and a melt flow rate in the range of 2 dg/min. to 100 dg/min., the multi-layer film is formed into a package adapted to contain a product. Preferably, the core layer is substantially free of the first polymer.

The invention also encompasses finished packages, pouches, sealed bags and other articles embodying the film structures above.

### BRIEF DESCRIPTION OF THE DRAWINGS

The drawing is a graph illustrating hermetic area, as determined by the test method described herein.

### DETAILED DESCRIPTION OF THE INVENTION

Various specific embodiments, versions and examples of the invention will now be described, including exemplary embodiments and definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to the appended claims, including their equivalents, and elements or limitations that are equivalent to those that are recited. Any reference to the “invention” may refer to one or more, but not necessarily all, of the inventions defined by the claims.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “isotactic” is defined as polymeric stereoregularity having at least 40% isotactic pentads of methyl groups derived from propylene according to analysis by ¹³C-NMR.

As used herein, “stereoregular” is defined to mean that the predominant number, e.g., greater than 80%, of the propylene residues in the polypropylene or in the polypropylene continuous phase of a blend, such as impact copolymer exclusive of any other monomer such as ethylene, has the same 1,2 insertion and the stereochemical orientation of the pendant methyl group is the same, either meso or racemic.

As used herein, “intermediate” is defined as the position of one layer of a multi-layer film wherein said layer lies between two other identified layers. In some embodiments, the intermediate layer may be in direct contact with either or both of the two identified layers. In other embodiments, additional layers may also be present between the intermediate layer and either or both of the two identified layers.

As used herein, “elastomer” is defined as a propylene-based or ethylene-based copolymer that can be extended or stretched with force to at least 100% of it original length, and upon removal of the force, rapidly (e.g., within 5 seconds) returns to its original dimensions.

As used herein, “plastomer” is defined as a propylene-based or ethylene-based copolymer having a density in the range of 0.850 g/cm³ to 0.920 g/cm³ and a DSC melting point of at least 40° C.

As used herein, “substantially free” is defined to mean that the referenced film layer is largely, but not wholly, absent a particular component (e.g., the first polymer). In some embodiments, small amounts of the component may be present within the referenced layer as a result of standard manufacturing methods, including recycling of film scraps and edge trim during processing.

As used herein, “first polymer” may be defined to include those homopolymers, copolymers, or polymer blends having at least one of the following sets of properties:
a) Density in the range of 0.850 g/cm³ to 0.920 g/cm³, a DSC melting point in the range of 40° C. to 160° C., and a MFR in the range of 2 dg/min. to 100 dg/min.;
b) A propylene-ethylene copolymer including from about 75 wt % to about 96 wt % propylene, from about 4 wt % to about 25 wt % ethylene and having a density in the range of 0.850 g/cm³ to 0.900 g/cm³;
c) A flexural modulus of not more than 2100 MPa and an elongation of at least 300%;
d) Isotactic stereoregularity, from about 84 wt % to about 93 wt % propylene, from about 7 wt % to about 16 wt % ethylene, a DSC melting point in the range of from about 42° C. to about 85° C., a heat of fusion less than 75 J/g, crystallinity from about 2% to about 65%, and a molecular weight distribution from about 2.0 to about 3.2;
e) A polymer blend, comprising at least one polymer (A) and at least one polymer (B), polymer (A) comprising from about 60 wt % to about 98 wt % of the blend, and polymer (A) comprising from about 82 wt % to about 93 wt % of units derived from propylene and from about 7 wt % to about 18 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A); and
f) A polymer blend, comprising at least one polymer (A) and at least one polymer (B), polymer (A) comprising from about 60 wt % to about 98 wt % of the blend, and polymer (A) comprising from about 65 wt % to about 96 wt % of units derived from propylene and from about 4 wt % to about 35 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

We have discovered certain film structures having improved properties. Films according to this invention comprise an arrangement of co-extruded polymeric layers that contribute individually and collectively to improving seal strength, hermeticity (e.g., a seal that does not allow the passage of gas, such as air), hot tack and reduced-temperature sealability of the film.

In the multi-layer films of this invention, a first polymer is incorporated into a tie layer to facilitate the improved properties listed above. Preferably, the first polymer is the sole or majority component of the first tie layer. A skin layer may also be provided.

In some embodiments, the film structures of the present invention have an improved tie layer and a core layer substantially free from a key polymer utilized in the tie layer. We have discovered particularly preferred polymers for use in the tie layer.

In a preferred embodiment, this invention relates to a multi-layer film, typically a polymeric film having improved sealing properties, comprising a core layer and a tie layer, the tie layer having at least 10 wt % of a first polymer having a density in the range of 0.850 g/cm³ to 0.920 g/cm³, a DSC melting point in the range of 40° C. to 160° C., and a MFR in the range of 2 dg/min. to 100 dg/min., the core layer being substantially free of the first polymer. More preferably, the first polymer is a propylene-ethylene copolymer, preferably with a propylene content of at least 75 wt % and an ethylene content in the range of 4 wt % to 25 wt %. Most preferably, the ethylene content is in the range of 8 wt % to 15 wt %.

### Core Layer

As is known to those skilled in the art, the core layer of a multi-layered film is most commonly the thickest layer and provides the foundation of the multi-layer structure. In some embodiments of this invention, the core layer comprises at least one polymer selected from the group consisting of propylene polymer, ethylene polymer, isotactic polypropylene (iPP), high crystallinity polypropylene (HCPP), ethylene-propylene (EP) copolymers, and combinations thereof. In a preferred embodiment, the core layer is an iPP homopolymer. An example of a suitable iPP is ExxonMobil PP4712E1 (commercially available from ExxonMobil Chemical Company of Baytown, Tex.). Another suitable iPP is Total Polypropylene 3371 (commercially available from Total Petrochemicals of Houston, Tex.). An example of HCPP is Total Polypropylene 3270 (commercially available from Total Petrochemicals of Houston, Tex.).

The core layer may further include a hydrocarbon resin. Hydrocarbon resins may serve to enhance or modify the flexural modulus, improve processability, or improve the barrier properties of the film. The resin may be a low molecular weight hydrocarbon that is compatible with the core polymer. Optionally, the resin may be hydrogenated. The resin may have a number average molecular weight less than 5000, preferably less than 2000, most preferably in the range of from 500 to 1000. The resin can be natural or synthetic and may have a softening point in the range of from 60° C. to 180° C.

Suitable hydrocarbon resins include, but are not limited to petroleum resins, terpene resins, styrene resins, and cyclopentadiene resins. In some embodiments, the hydrocarbon resin is selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and combinations thereof.

Hydrocarbon resins that may be suitable for use as described herein include EMPR 120, 104, 111, 106, 112, 115, EMFR 100 and 100A, ECR-373 and ESCOREZ® 2101, 2203, 2520, 5380, 5600, 5618, 5690 (commercially available from ExxonMobil Chemical Company of Baytown, Tex.); ARKON™ M90, M100, M115 and M135 and SUPER ESTER™ rosin esters (commercially available from Arakawa Chemical Company of Japan); SYLVARES™ phenol modified styrene, methyl styrene resins, styrenated terpene resins, ZONATAC™ terpene-aromatic resins, and terpene phenolic resins (commercially available from Arizona Chemical Company of Jacksonville, Fla.); SYLVATAC™ and SYLVALITE™ rosin esters (commercially available from Arizona Chemical Company of Jacksonville, Fla.); NORSOLENE™ aliphatic aromatic resins (commercially available from Cray Valley of France); DERTOPHENE™ terpene phenolic resins (commercially available from DRT Chemical Company of Landes, France); EASTOTAC™ resins, PICCOTAC™ C₅/C₉ resins, REGALITE™ and REGALREZ™ aromatic and REGALITE™ cycloaliphatic/aromatic resins (commercially available from Eastman Chemical Company of Kingsport, Tenn.); WINGTACK™ ET and EXTRA™ (commercially available from Sartomer of Exton, Pa.); FORAL™, PENTALYN™, and PERMALYN™ rosins and rosin esters (commercially available from Hercules, now Eastman Chemical Company of Kingsport, Tenn.); QUINTONE™ acid modified C₅ resins, C₅/C₉ resins, and acid modified C₅/C₉ resins (commercially available from Nippon Zeon of Japan); and LX™ mixed aromatic/cycloaliphatic resins (commercially available from Neville Chemical Company of Pittsburgh, Pa.); CLEARON™ hydrogenated terpene aromatic resins (commercially available from Yasuhara of Japan); and PICCOLYTE™ (commercially available from Loos & Dilworth, Inc. of Bristol, Pa.). Other suitable hydrocarbon resins may be found in U.S. Pat. No. 5,667,902, incorporated herein by reference. The preceding examples are illustrative only and by no means limiting.

Preferred hydrocarbon resins for use in the films of this invention include saturated alicyclic resins. Such resins, if used, may have a softening point in the range of from 85° C. to 140° C., or preferably in the range of 100° C. to 140° C., as measured by the ring and ball technique. Examples of suitable, commercially available saturated alicyclic resins are ARKON-P™ (commercially available from Arakawa Forest Chemical Industries, Ltd., of Japan).

The amount of such hydrocarbon resins, either alone or in combination, in the core layer is preferably less than 20 wt %, more preferably in the range of from 1 wt % to 5 wt %, based on the total weight of the core layer.

The core layer may further comprise one or more additives such as opacifying agents, pigments, colorants, cavitating agents, slip agents, antioxidants, anti-fog agents, anti-static agents, fillers, moisture barrier additives, gas barrier additives, and combinations thereof, as discussed in further detail below. A suitable anti-static agent is ARMOSTAT™ 475 (commercially available from Akzo Nobel of Chicago, Ill.).

Cavitating agents may be present in the core layer in an amount less than 30 wt %, preferably less than 20 wt %, most preferably in the range of from 2 wt % to 10 wt %, based on the total weight of the core layer. Alternatively, the core layer may be cavitated by beta nucleation.

Preferably, the total amount of additives in the core layer comprises up to about 20 wt % of the core layer, but some embodiments may comprise additives in the core layer in an amount up to about 30 wt % of the core layer.

The core layer preferably has a thickness in the range of from about 5 μm to 100 μm, more preferably from about 5 μm to 50 μm, most preferably from 5 μm to 25 μm.

### First Tie Layer

As is known to those skilled in the art, the tie layer of a multi-layer film is typically used to connect two other, partially or fully incompatible, layers of the multi-layer film structure, e.g., a core layer and a skin layer, and is positioned intermediate these other layers.

In some embodiments of this invention, the first tie layer is in direct contact with the surface of the core layer. In other embodiments, another layer or layers may be intermediate the core layer and the first tie layer. The first tie layer comprises a first polymer, as defined above, and, optionally, one or more other polymers. Preferably, the first polymer comprises C₂C₃ random copolymers, C₂C₃C₄ random terpolymers, heterophasic random copolymers, C₄ homopolymers, C₄ copolymers, metallocene polypropylenes, propylene-based or ethylene-based elastomers and/or plastomers, or combinations thereof. In preferred embodiments, the first polymer has a density in the range of 0.850 g/cm³ to 0.920 g/cm³, a DSC melting point in the range of 40° C. to 160° C., and a MFR in the range of 2 dg/min. to 100 dg/min. More preferably, the first polymer is a grade of VISTAMAXX™ polymer (commercially available from ExxonMobil Chemical Company of Baytown, Tex.). Preferred grades of VISTAMAXX™ are VM6100 and VM3000. Alternatively, the first polymer may be a suitable grade of VERSIFY™ polymer (commercially available from The Dow Chemical Company of Midland, Mich.), Basell CATALLOY™ resins such as ADFLEX™ T100F, SOFTELL™ Q020F, CLYRELL™ SM1340 (commercially available from Basell Polyolefins of The Netherlands), PB (propylene-butene-1) random copolymers such as Basell PB 8340 (commercially available from Basell Polyolefins of The Netherlands), Borealis BORSOFT™ SD233CF, (commercially available from Borealis of Denmark), EXCEED™ 1012CA and 1018CA metallocene polyethylenes, EXACT™ 5361, 4049, 5371, 8201, 4150, 3132 polyethylene plastomers, EMCC 3022.32 low density polyethylene (LDPE) (commercially available from ExxonMobil Chemical Company of Baytown, Tex.), Total Polypropylene 3371 polypropylene homopolymer (commercially available from Total Petrochemicals of Houston, Tex.) and JPP 7500 C₂C₃C₄ terpolymer (commercially available from Japan Polypropylene Corporation of Japan).

In the most preferred embodiments, the first polymer is a propylene-ethylene copolymer and the first tie layer comprises at least 10 wt % of the first polymer in the first tie layer, preferably at least 25 wt % of the first polymer in the first tie layer, more preferably at least 50 wt % of the first polymer in the first tie layer, and most preferably at least 90 wt % of the first polymer in the first tie layer. In some preferred embodiments, the first tie layer comprises about 100 wt % of the first polymer.

In some embodiments, the first polymer has a propylene content ranging from 75 wt % to 96 wt %, preferably ranging from 80 wt % to 95 wt %, more preferably ranging from 84 wt % to 94 wt %, most preferably ranging from 85 wt % to 92 wt %, and an ethylene content ranging from 4 wt % to 25 wt %, preferably ranging from 5 wt % to 20 wt %, more preferably ranging from 6 wt % to 16 wt %, most preferably ranging from 8 wt % to 15 wt %.

The first polymer preferably has a density ranging from 0.850 g/cm³ to 0.920 g/cm³, more preferably ranging from 0.850 g/cm³ to 0.900 g/cm³, most preferably from 0.870 g/cm³ to 0.885 g/cm³.

The DSC melting point of the first polymer preferably ranges from 40° C. to 160° C., more preferably from 60° C. to 120° C. Most preferably, the DSC melting point is below 100° C.

In some embodiments, the first polymer has a MFR ranging from 2 dg/min. to 100 dg/min., preferably ranging from 5 dg/min. to 50 dg/min., more preferably ranging from 5 dg/min. to 25 dg/min., most preferably from 5 dg/min. to 10 dg/min.

The first polymer may further have a molecular weight distribution (MWD) below 7.0, preferably ranging from 1.8 to 5.0, more preferably ranging from 2.0 to 3.2, most preferably, less than or equal to 3.2.

The first polymer has a flexural modulus of preferably not more than 2100 MPa, more preferably not more than 1500 MPa, most preferably ranging from 20 MPa to 700 MPa.

The elongation of the first polymer is preferably at least 300%, more preferably at least 400%, even more preferably at least 500%, and most preferably greater than 1000%. In some cases, elongations of 2000% or more are possible.

The heat of fusion of the first polymer is preferably less than 75 J/g.

In some embodiments, the first polymer has isotactic stereoregular crystallinity. In other embodiments, the first polymer has a crystallinity ranging from 2% to 65%.

The first polymer may be produced via a single site catalyst polymerization process. In some embodiments, the single site catalyst incorporates hafnium.

The first tie layer may also comprise one or more additional polymers. When one or more additional polymers are present, the first polymer is preferably present in an amount of from at least about 25 wt % to about 75 wt % of the first tie layer. Amounts of the first polymer of less than 25 wt % (e.g., 10 wt %) or greater than 75 wt % (e.g., 90 wt % or more) are also permissible, depending upon the desired properties for the multi-layer film product. The optional additional polymers may comprise one or more C₂-C₈ homopolymers, copolymers, or terpolymers. Preferably, the additional polymer is comprised of at least one of an iPP homopolymer, an EP copolymer, and combinations thereof An example of a suitable iPP homopolymer is Total Polypropylene 3371 (commercially available from Total Petrochemicals of Houston, Tex.)

In some embodiments, the first tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

The thickness of the first tie layer is typically in the range of from about 0.50 to 25 μm, preferably from about 0.50 μm to 12 μm, more preferably from about 0.50 μm to 6 μm, and most preferably from about 2.5 μm to 5 μm. However, in some thinner films, the first tie layer thickness may be from about 0.5 μm to 4 μm, or from about 0.5 μm to 2 μm, or from about 0.5 μm to 1.5 μm.

### First Skin Layer

In some embodiments of this invention, the first skin layer is contiguous to the first tie layer. In other embodiments, one or more other layers may be intermediate the first tie layer and the first skin layer. The first skin layer includes a polymer that is suitable for heat-sealing or bonding to itself when crimped between heated crimp-sealer jaws. Commonly, suitable skin layer polymers include copolymers or terpolymers of ethylene, propylene, and butylene and may have DSC melting points either lower than or greater than the DSC melting point of the first polymer. In some preferred embodiments, the first skin layer comprises at least one polymer selected from the group consisting of propylene homopolymer, ethylene-propylene copolymer, butylene homopolymer and copolymer, ethylene-propylene-butylene (EPB) terpolymer, ethylene vinyl acetate (EVA), metallocene-catalyzed propylene homopolymer, and combinations thereof. An example of a suitable EPB terpolymer is Chisso 7794 (commercially available from Chisso Corporation of Japan).

Heat sealable blends can be utilized in providing the first skin layer. Thus, along with the skin layer polymer identified above there can be, for example, other polymers, such as polypropylene homopolymer, e.g., one that is the same as, or different from, the iPP of the core layer. The first skin layer may additionally or alternatively include materials selected from the group consisting of ethylene-propylene random copolymers, LDPE, linear low density polyethylene (LLDPE), medium density polyethylene (MDPE), and combinations thereof.

The first skin layer may also comprise processing aid additives, such as anti-block agents, anti-static agents, slip agents and combinations thereof, as discussed in further detail below.

The thickness of the first skin layer is typically in the range of from about 0.10 μm to 7.0 μm, preferably about 0.10 μm to 4 μm, and most preferably about 0.10 μm to 3 μm. In some film embodiments, the first skin layer thickness may be from about 0.10 μm to 2 μm, 0.10 μm to 1 μm, or 0.10 μm to 0.50 μm. In some commonly preferred film embodiments, the first skin layer has a thickness in the range of from about 0.5 μm to 2 μm, 0.5 μm to 3 μm, or 1 μm to 3.5 μm.

### Second Skin Layer

A second skin layer is optional and when present is provided on the opposite side of the core layer from the first skin layer. The second skin layer may be contiguous to the core layer or contiguous to one or more other layers positioned intermediate the core layer and the second skin layer. The second skin layer may be provided to improve the film's barrier properties, processability, printability, and/or compatibility for metallization, coating, and lamination to other films or substrates.

In some embodiments, the second skin layer comprises at least one polymer selected from the group consisting of a PE polymer or copolymer, a PP polymer or copolymer, an ethylene-propylene copolymer, an EPB terpolymer, a PB copolymer, an ethylene-vinyl alcohol (EVOH) polymer, and combinations thereof Preferably, the PE polymer is high-density polyethylene (HDPE), such as HD-6704.67 (commercially available from ExxonMobil Chemical Company of Baytown, Tex.), M-6211 and HDPE M-6030 (commercially available from Equistar Chemical Company of Houston, Tex.). A suitable ethylene-propylene copolymer is Fina 8573 (commercially available from Fina Oil Company of Dallas, Tex.). Preferred EPB terpolymers include Chisso 7510 and 7794 (commercially available from Chisso Corporation of Japan). For coating and printing functions, the second skin layer may preferably comprise a copolymer that has been surface treated. For metalizing or barrier properties, a HDPE, a PB copolymer, PP or EVOH may be preferred. A suitable EVOH copolymer is EVAL™ G176B (commercially available from Kuraray Company Ltd. of Japan).

The second skin layer may also comprise processing aid additives, such as anti-block agents, anti-static agents, slip agents and combinations thereof, as discussed in further detail below.

The thickness of the second skin layer depends upon the intended function of the second skin layer, but is typically in the range of from about 0.50 μm to 3.5 μm, preferably from about 0.50 μm to 2 μm, and in many embodiments most preferably from about 0.50 μm to 1.5 μm. Also, in thinner film embodiments, the second skin layer thickness may range from about 0.50 μm to 1.0 μm, or 0.50 μm to 0.75 μm.

### Second Tie Layer

A second tie layer is optional and when present is located intermediate the core layer and the second skin layer. In one embodiment, the second tie layer comprises a blend of propylene homopolymer and, optionally, at least one first polymer, as described above. The propylene homopolymer is preferably an iPP. The first polymer preferably comprises at least 10 wt % of the second tie layer, more preferably at least 90 wt % of the second tie layer. In some preferred embodiments, the second tie layer is an adhesion promoting material such as ADMER™ AT1179A (commercially available from Mitsui Chemicals America Inc. of Purchase, N.Y.), a maleic anhydride modified polypropylene.

The second tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

The thickness of the second tie layer is in the range of from about 0.5 μm to 25 μm, preferably from about 1 μm to 12 μm, and most preferably from about 1 μm to 10 μm. Also, the thickness may be from about 0.5 μm to 8 μm, or 1 μm to 6 μm, or 1 μm to 4 μm.

### Additives

Additives that may be present in one or more layers of the multi-layer films of this invention, include, but are not limited to opacifying agents, pigments, colorants, cavitating agents, slip agents, antioxidants, anti-fog agents, anti-static agents, anti-block agents, fillers, moisture barrier additives, gas barrier additives and combinations thereof. Such additives may be used in effective amounts, which vary depending upon the property required.

Examples of suitable opacifying agents, pigments or colorants are iron oxide, carbon black, aluminum, titanium dioxide (TiO₂), calcium carbonate (CaCO₃), polybutylene terephthalate (PBT), talc, beta nucleating agents, and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. Cavitation may also be introduced by beta-cavitation, which includes creating beta-form crystals of polypropylene and converting at least some of the beta-crystals to alpha-form polypropylene crystals and creating a small void remaining after the conversion. Preferred beta-cavitated embodiments of the core layer may also comprise a beta-crystalline nucleating agent. Substantially any beta-crystalline nucleating agent (“beta nucleating agent” or “beta nucleator”) may be used. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful for this invention is erucamide.

Non-migratory slip agents, used in one or more skin layers of the multi-layer films of this invention, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Fillers useful in this invention may include finely divided inorganic solid materials such as silica, fumed silica, diatomaceous earth, calcium carbonate, calcium silicate, aluminum silicate, kaolin, talc, bentonite, clay and pulp.

Suitable moisture and gas barrier additives may include effective amounts of low-molecular weight resins, hydrocarbon resins, particularly petroleum resins, styrene resins, cyclopentadiene resins, and terpene resins.

Optionally, one or more skin layers may be compounded with a wax or coated with a wax-containing coating, for lubricity, in amounts ranging from 2 wt % to 15 wt % based on the total weight of the skin layer. Any conventional wax, such as, but not limited to Carnauba™ wax (commercially available from Michelman Corporation of Cincinnati, Ohio) that is useful in thermoplastic films is contemplated.

### Film Orientation

The embodiments of this invention include possible uniaxial or biaxial orientation of the multi-layer films. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by TD orientation. Blown films or cast films may also be oriented by a tenter-frame orientation subsequent to the film extrusion process, again in one or both directions. Orientation may be sequential or simultaneous, depending upon the desired film features. Preferred orientation ratios are commonly from between about three to about six times the extruded width in the machine direction and between about four to about ten times the extruded width in the transverse direction. Typical commercial orientation processes are BOPP tenter process, blown film, and LISIM technology.

### Surface Treatment

One or both of the outer surfaces of the multi-layer films of this invention may be surface-treated to increase the surface energy to render the film receptive to metallization, coatings, printing inks, and/or lamination. The surface treatment can be carried out according to one of the methods known in the art including corona discharge, flame, plasma, chemical treatment, or treatment by means of a polarized flame.

### Metallization

One or both of the outer surfaces of the multi-layer films of this invention may be metallized. Such layers may be metallized using conventional methods, such as vacuum metallization by deposition of a metal layer such as aluminum, copper, silver, chromium, or mixtures thereof.

### Coating

In some embodiments, one or more coatings, such as for barrier, printing and/or processing, may be applied to one or both of the outer surfaces of the multi-layer films of this invention. Such coatings may include acrylic polymers, such as ethylene acrylic acid (EAA), ethylene methyl acrylate copolymers (EMA), polyvinylidene chloride (PVdC), poly(vinyl)alcohol (PVOH) and EVOH. The coatings are preferably applied by an emulsion coating technique, but may also be applied by co-extrusion and/or lamination.

The PVdC coatings that are suitable for use with the multi-layer films of this invention are any of the known PVdC compositions heretofore employed as coatings in film manufacturing operations, e.g., any of the PVdC materials described in U.S. Pat. No. 4,214,039, U.S. Pat. No. 4,447,494, U.S. Pat. No. 4,961,992, U.S. Pat. No. 5,019,447, and U.S. Pat. No. 5,057,177, incorporated herein by reference.

Known vinyl alcohol-based coatings, such as PVOH and EVOH, that are suitable for use with the multi-layer films invention include VINOL™ 125 or VINOL™ 325 (both commercially available from Air Products, Inc. of Allentown, Pa.). Other PVOH coatings are described in U.S. Pat. No. 5,230,963, incorporated herein by reference.

Before applying the coating composition to the appropriate substrate, the outer surface of the film may be treated as noted herein to increase its surface energy. This treatment can be accomplished by employing known techniques, such as flame treatment, plasma, corona discharge, film chlorination, e.g., exposure of the film surface to gaseous chlorine, treatment with oxidizing agents such as chromic acid, hot air or steam treatment, flame treatment and the like. Although any of these techniques is effectively employed to pre-treat the film surface, a frequently preferred method is corona discharge, an electronic treatment method that includes exposing the film surface to a high voltage corona discharge while passing the film between a pair of spaced electrodes. After treatment of the film surface, the coating composition is then applied thereto.

An intermediate primer coating may be applied to multi-layer films of this invention. In this case, the film may be first treated by one of the foregoing methods to provide increased active adhesive sites thereon and to the thus-treated film surface there may be subsequently applied a continuous coating of a primer material. Such primer materials are well known in the art and include, for example, epoxy and poly(ethylene imine) (PEI) materials. U.S. Pat. No. 3,753,769, U.S. Pat. No. 4,058,645 and U.S. Pat. No. 4,439,493, each incorporated herein by reference, disclose the use and application of such primers. The primer provides an overall adhesively active surface for thorough and secure bonding with the subsequently applied coating composition and can be applied to the film by conventional solution coating means, for example, by roller application.

The coating composition can be applied to the film as a solution, one prepared with an organic solvent such as an alcohol, ketone, ester, and the like. However, since the coating composition can contain insoluble, finely divided inorganic materials that may be difficult to keep well dispersed in organic solvents, it is preferable that the coating composition be applied to the treated surface in any convenient manner, such as by gravure coating, roll coating, dipping, spraying, and the like. The excess aqueous solution can be removed by squeeze rolls, doctor knives, and the like.

The film can be stretched in the MD, coated with the coating composition and then stretched perpendicular in the TD. In yet another embodiment, the coating can be carried out after biaxial orientation is completed.

The coating composition may be applied in such an amount that there will be deposited upon drying a smooth, evenly distributed layer. The coating may be dried by hot air, radiant heat, or by any other convenient means. Coatings useful in this invention may have coating weights ranging from 0.5 g/m² to 1.6 g/m² for conventional PVOH coatings, 0.78 g/m² to 2.33 g/m² for conventional acrylic and low temperature seal coatings (LTSC) and 1.6 g/m² to 6.2 g/m² for conventional PVdC coatings.

### INDUSTRIAL APPLICABILITY

Multi-layer films according to the present invention are useful as substantially stand-alone film webs or they may be coated, metallized, and/or laminated to other film structures. Multi-layer films according to the present invention may be prepared by any suitable methods comprising the steps of co-extruding a multi-layer film according to the description and claims of this specification, orienting and preparing the film for intended use such as by coating, printing, slitting, or other converting methods. Preferred methods comprise co-extruding, then casting and orienting the multi-layer film, as discussed in this specification.

For some applications, it may be desirable to laminate the multi-layer films of this invention to other polymeric film or paper products for purposes such as package decor including printing and metalizing. These activities are typically performed by the ultimate end-users or film converters who process films for supply to the ultimate end-users.

In one embodiment, a method of preparing a multi-layer film according to the present invention comprises the steps of co-extruding at least:

a core layer;

a tie layer, the tie layer containing at least 10 wt % of a first polymer having a density in the range of 0.850 g/cm³ to 0.920 g/cm³, a DSC melting point in the range of 40° C. to 160° C., and MFR in the range of 2 dg/min. to 100 dg/min.;

a skin layer;

the tie layer being intermediate the core layer and the skin layer; and

the core layer being substantially free of the first polymer.

The method may further comprise the step of orienting the co-extruded, multi-layer film in at least one direction.

The method may further comprise the steps of enclosing a product or article within at least a portion of the co-extruded film, engaging a first portion of the skin layer with a second portion of the skin layer at a seal area, and applying pressure and heat at the seal area, optionally for a determined duration of time, to cause the first portion to engage with the second portion to create at least one of a fin seal, a lap seal, and a crimp seal in the seal area.

The method may further comprise additionally co-extruding a second tie layer and a second skin layer on the multi-layer film.

The prepared multi-layer film may be used as a flexible packaging film to package an article or good, such as a food item or other product. In some applications, the film may be formed into a pouch type of package, such as may be useful for packaging a beverage, liquid, granular, or dry-powder product.

### Experimental

The multi-layer film of the present invention will be further described with reference to the following non-limiting examples.

### Testing Methods

Density is measured according to ASTM D-1505 test method.

The procedure for Differential Scanning calorimetry (DSC) is described as follows. From about 6 mg to about 10 mg of a sheet of the polymer pressed at approximately 200° C. to 230° C. is removed with a punch die. This is annealed at room temperature for at least 2 weeks. At the end of this period, the sample is placed in a Differential Scanning calorimeter (TA Instruments Model 2920 DSC) and cooled to about −50° C. to about −70° C. The sample is heated at 20° C./min to attain a final temperature of about 200° C. to about 220° C. The thermal output is recorded as the area under the melting peak of the sample which is typically peaked at about 30° C. to about 175° C. and occurs between the temperatures of about 0° C. and about 200° C. is a measure of the heat of fusion expressed in Joules per gram of polymer. The melting point is recorded as the temperature of the greatest heat absorption within the range of melting of the sample.

Melt Flow Rate (MFR) is measured according to ASTM D-1238, 2.16 kg. at 230° C. with a 1 minute preheat on the sample to provide a steady temperature for the duration of the experiment.

Techniques for determining the molecular weight distribution (MWD) may be found in U.S. Pat. No. 4,540,753, incorporated herein by reference, and references cited therein and in Macromolecules, 1988, volume 21, p 3360, which is incorporated herein by reference, and references cited therein.

Flexural modulus is measured according to ASTM D-790 test method.

Elongation at break is measured according to ASTM D-638 test method.

Heat of Fusion is measured according to ASTM E 794-85 test method.

Percent crystallinity was derived from the thermal output measurement of the DSC procedure described above. The thermal output for the highest order of polypropylene is estimated at 189 J/g (i.e., 100% crystallinity is equal to 189 J/g).

Seal strength may be determined using sealing devices such as a LAKO™ Heat Sealer (Model SL-10), HAYSSEN™ Heat Sealer (Model Ultimate II), and a FUJI™ Heat Sealer (Model Alpha V). Also, the seal strength of flexible barrier materials may be determined according to the standard testing method of ASTM F 88-00.

Minimum seal temperature (MST) is determined as follows: heat seals are formed using one of the above heat sealers at temperatures that are raised incrementally. The minimum seal temperature is reached when one temperature yields a seal value of less than a specified g/cm. peel force and the next temperature yields a seal value of greater than or equal to the specified g/cm. peel force. The specified peel force of the LAKO™ Heat Sealer, HAYSSEN™ Heat Sealer and the FUJI™ Heat Sealer is 80 g/cm.

A LAKO™ Heat Sealer (Model SL-10), (commercially available from Lako Tool & Manufacturing, Inc. of Perrysburg, Ohio), may be used to form a seal and evaluate its seal strength. The LAKO™ Heat Sealer is an automated film testing device that is capable for forming a film seal, determining the seal strength, and generating a seal profile from film samples. The operating range is from ambient to 199° C., sealing pressure of 0.04 MPa to 2.69 MPa, and a dwell time of 0.2 seconds to 20 seconds.

The seal strength of a seal formed using the HAYSSEN™ Ultimate II vertical form, fill and seal (VFFS) machine (commercially available from Hayssen Packaging Technologies of Duncan, S.C.), may be determined as follows: a film or lamination is placed on the machine. The crimp temperature is set at or above the MST of the film or lamination. The lap and/or fin seal temperature is set above the MST of the film or lamination. A total of six to nine empty bags measuring approximately 35.6 cm by 13.3 cm are produced at the rate 55 bags/min. Two bags are randomly selected and seal strengths are measured on a Suter tester. Preferred seal strength range is greater than 80 g/cm. The crimp temperature is increased in increments of approximately 5.5° C. and the test is repeated according to the steps above until the film or lamination is visually, thermally distorted. The seal range is reported as upper crimp distortion temperature minus the crimp MST. The method described above is repeated to determine the seal strength of the lap and/or fin seal.

The seal strength of a seal formed using a FUJI™ Heat Sealer (Alpha V) machine (commercially available from Fuji Packaging Co. Ltd. of Japan), may be determined as follows: a roll of film or lamination is placed on the machine. The crimp temperature is set at or above the MST of the film or lamination. The lap and/or fin seal temperature is set above the MST of the film or lamination. A total of twenty empty bags measuring approximately 35.6 cm by 13.3 cm are produced at the rate 150 bags/min. Two bags are randomly selected and seal strengths are measured on a Suter tester. Preferred seal strength range is greater than 80 g/cm.

Hot tack performance may be determined using devices such as a HAYSSEN™ Ultimate II VFFS machine (commercially available from Hayssen Packaging Technologies of Duncan, S.C.), as follows: a roll of film or lamination is placed on the VFFS machine. The crimp temperature is set at or above the MST of the film or lamination. The lap and/or fin seal temperature is set above the MST of the film or lamination. A total of six to nine empty bags measuring approximately 35.6 cm by 13.3 cm are produced at the rate 55 bags/min. Three bags are randomly selected and filled with approximately 454 grams of large particulate product. The bags are then examined for seal creep (e.g., loosening or release of seal width). Preferred seal creep is less than 0.16 cm for all crimp seals and lap and/or fin seals on the bag. The crimp temperature is increased in increments of approximately 5.5° C. and the test is repeated according to the steps above until the film or lamination is visually, thermally distorted. Seal and hot tack range is reported as upper seal distortion temperature minus the seal MST.

Hermetic area may be determined using devices such as a HAYSSEN™ Ultimate II VFFS machine (commercially available from Hayssen Packaging Technologies of Duncan, S.C.), at the speed of 55 bags/min. Empty bags measuring approximately 35.6 cm by 13.3 cm filled with air are sealed at specified temperatures for lap and/or fin seal at the back of the bag and crimp seal on both ends of the bag. Twenty bags are put under water at 20.3 cm Hg vacuum for 60 seconds. If no bubbles are observed from all 20 of the submersed bags, the seal is considered a hermetic seal under the test conditions. If even one of the twenty bags bubbles, the seal is not hermetic. The temperature settings are modified incrementally and the test is repeated until the hermetic area is determined As illustrated in the drawing, test results are recorded on a graph with tested crimp seal temperatures on the x-axis in increasing increments of 5.5° C. and lap and/or fin seal temperatures on the y-axis in increasing increments of 5.5° C. The graph is proportionally divided into contiguous, non-overlapping boxes. As shown by the shaded area 10 of the drawing, each test resulting in a hermetic seal is represented by one shaded box on the graph corresponding to the lap and/or fin seal and crimp seal temperature settings. The final hermetic area is determined by calculating the total of all filled boxes on the graph. For example, in the drawing, the hermetic area is 47 boxes. The hermetic area of the multi-layer films of this invention range from about 23 boxes to greater than 67 boxes.

### EXAMPLES

### Comparative Example 1

The multi-layer film of Comparative Example 1 was melt coextruded, quenched on a casting drum and subsequently reheated in the machine direction orienter (MDO) to about 85° C. to 105° C. The film was then stretched in the MD at 4.3 times and further annealed in the annealing sections of the machine direction orienter.

The MD stretched basesheet was subjected to further TD orientation via conventional tenter frame at nine times in the TD. The typical transverse direction preheat temperature is about 155° C. to 180° C., stretching temperature is about 145° C. to 165° C., and standard annealing temperature is about 165° C. to 170° C.

The second skin was further treated by a conventional flame treatment method and then wound in a mill roll form. The overall thickness of the finished film is about 31.25μ. The film had a four layer structure, as follows:

| | | Thickness |
|---|---|---|
| | Polymer | (μm) |
| First skin layer | Chisso 7794 - C₂C₃C₄ terpolymer | 2 |
| Tie layer | Total 3371 - PP homopolymer | 5 |
| Core layer | Total 3371 - PP homopolymer | 23.7 |
| Second skin layer | Chisso 7510 - C₂C₃C₄ terpolymer | 0.6 |

The film sample in Comparative Example 1 was further tested for seal range, seal strength and hot tack strength by:
1. Lab LAKO™ sealer
2. VFFS packaging machine
3. HFFS packaging machine
   Results are provided in Table 1, below.

### Example 2

Comparative Example 1 was repeated, except the tie layer was changed from a Ziegler-Natta isotactic PP to a VM3000 propylene-ethylene copolymer.

The film had a four layer structure, as follows:

| | | Thickness |
|---|---|---|
| | Polymer | (μm) |
| First skin layer | Chisso 7794 - C₂C₃C₄ terpolymer | 2 |
| Tie layer | EMCC VM3000 - propylene-ethylene | 5 |
| | copolymer | |
| Core layer | Total 3371 - PP homopolymer | 23.7 |
| Second skin layer | Chisso 7510 - C₂C₃C₄ terpolymer | 0.6 |

### Example 3 to 9

Example 2 was repeated, but the first tie layer polymers, all of which are “first polymers” as defined herein, were as follows:

| Example | Tie layer resin |
|---|---|
| 3 | Borsoft SD233CF - heterophasic random copolymer |
| 4 | VM6100 - propylene-ethylene copolymer |
| 5 | EMCC 3002.32 LLDPE - hexene copolymer |
| 6 | Exact 4049 - ethylene-butene copolymer |
| 7 | Basell Adflex T100F - heterophasic random copolymer |
| 8 | VM 3000 - propylene-ethylene copolymer + 50% |
| | Total 3371 - PP homopolymer |
| 9 | VM 3000 - propylene-ethylene copolymer + 75% |
| | Total 3371 - PP homopolymer |

The films samples from Examples 1 through 9 were tested for seal range, seal strength and hot tack as described herein. A summary is provided in Table 1, below.

TABLE 1

| | | | | Hayssen | | Fuji |
|---|---|---|---|---|---|---|
| | | | Hayssen | VFFS | | HFFS |
| | | Lako | VFFS | ultimate | | ultimate |
| | Lako | ultimate | seal and | seal | Fuji | seal |
| | MST | seal | hot tack | strength | HFFS seal | strength |
| Example | (C.) | (g/cm) | range (C.) | (g/cm) | range (C.) | (g/cm) |
| 1 | 90 | 393 | 38 | 678 | 10 | 596 |
| 2 | 74 | 1,120 | 54 | >1,200* | 27 | >1,200* |
| 3 | 86 | 1,089 | 43 | >1,200* | 27 | >1,200* |
| 4 | 77 | 1,003 | 54 | 1,078 | 27 | >1,200* |
| 5 | 83 | 694 | 49 | 1,022 | 27 | >1,200* |
| 6 | 72 | 750 | 60 | 1,004 | 38 | 1,000 |
| 7 | 83 | 1,073 | 49 | 1,096 | 21 | 904 |
| 8 | 84 | 1,122 | 49 | >1,200* | 21 | >1,200* |
| 9 | 79 | 1,218 | 54 | >1,200* | 21 | >1,200* |

*>means seal strengths exceeded the measuring capability of the test equipment.

Example 2 through Example 9 demonstrate improvements resulting from this invention when compared to control Example 1 including:
Broadening the VFFS seal range by 5° C. to 22° C. This improvement is significant and is about 20% to 40% of a very good terpolymer heat sealing resin.
Broadening the HFFS seal range by 11° C. to 28° C. As in VFFS, the improvement in HFFS is extraordinary and significant. One sample doubled the seal range and the improvement was 40% to 100%. This is truly outstanding.
Delivering outstanding ultimate seal strength. By LAKO™ test, ultimate seal strength was improved by 1.8 to 2.5 times. By VFFS and HFFS, ultimate seals in this invention were >1,200 g/cm which were off scale based on the lab Suter tester unit. We took empty bags from Sample 2 and tested 2,036 g/cm on an Instron® machine. Many of the >1,200 g/cm samples have potentially very high seal strength.
Maintaining excellent hot tack throughout the seal range as shown by VFFS test method. Seal range is defined by acceptable hot tack and seal strength is greater than 80 g/cm. Both seal strength and hot tack were tested using ExxonMobil Chemical Company test methods defined above.

### Comparative Example 10

Comparative Example 1 was repeated in an 18μ structure with the following layer thicknesses and configuration:

| | Polymer | Thickness (μm) |
|---|---|---|
| First skin layer | Chisso 7794 - C₂C₃C₄ terpolymer | 2 |
| Tie layer | Total 3371 - PP homopolymer | 5 |
| Core layer | Total 3371 - PP homopolymer | 10.4 |
| Second skin layer | Chisso 7510 - C₂C₃C₄ terpolymer | 0.6 |

The film sample in Comparative Example 10 was further tested for seal range, seal strength, hot tack strength and hermeticity by:
1. Lab LAKO™ sealer on plain film
2. VFFS packaging machine on laminations
3. HFFS packaging machine on laminations
4. Hermeticity on laminations

A three-layer laminated structure was prepared as follows: 70 SLP/10# Chevron 1017/Comparative Example 10. 70 SLP is an ExxonMobil Chemical Company commercial product and is not heat sealable. This product was selected in order to allow fin seal testing of the laminated product.

### Example 11

Comparative Example 10 was repeated, including lamination, except the tie layer was changed from a Ziegler-Natta isotactic PP to a VM3000 propylene-ethylene copolymer.

The film had a four layer structure, as follows:

| | Polymer | Thickness (μm) |
|---|---|---|
| First skin layer | Chisso 7794 - C₂C₃C₄ terpolymer | 2 |
| Tie layer | EMCC VM3000 - propylene-ethylene | 5 |
| | copolymer | |
| Core layer | Total 3371 - PP homopolymer | 10.4 |
| Second skin layer | Chisso 7510 - C₂C₃C₄ terpolymer | 0.6 |

### Example 12 to 18

Example 11 was repeated, but the first tie layer polymers were as follows:

| Example | Tie layer resin |
|---|---|
| 12 | Borsoft SD233CF - heterophasic random copolymer |
| 13 | VM6100 - propylene-ethylene copolymer |
| 14 | EMCC 3002.32 LLDPE - hexene copolymer |
| 15 | Exceed 1012 CA - VLDPE hexene copolymer |
| 16 | Basell Adflex T100F - heterophasic random copolymer |
| 17 | JPP 7500 - C₂C₃C₄ terpolymer |
| 18 | Basell PB 8340 - PB random copolymer |

The three-layer laminated structure of Examples 11 through 18 was prepared as follows: 70 LCX/10# Chevron 1017/Comparative Example 10. 70 LCX is an ExxonMobil Chemical Company commercial product and is heat-sealable on only one side. This product was selected to allow lap seal hermeticity testing of the laminated product.

The films samples from Examples 10 through 18 were tested, and a summary is in Table 2, below.

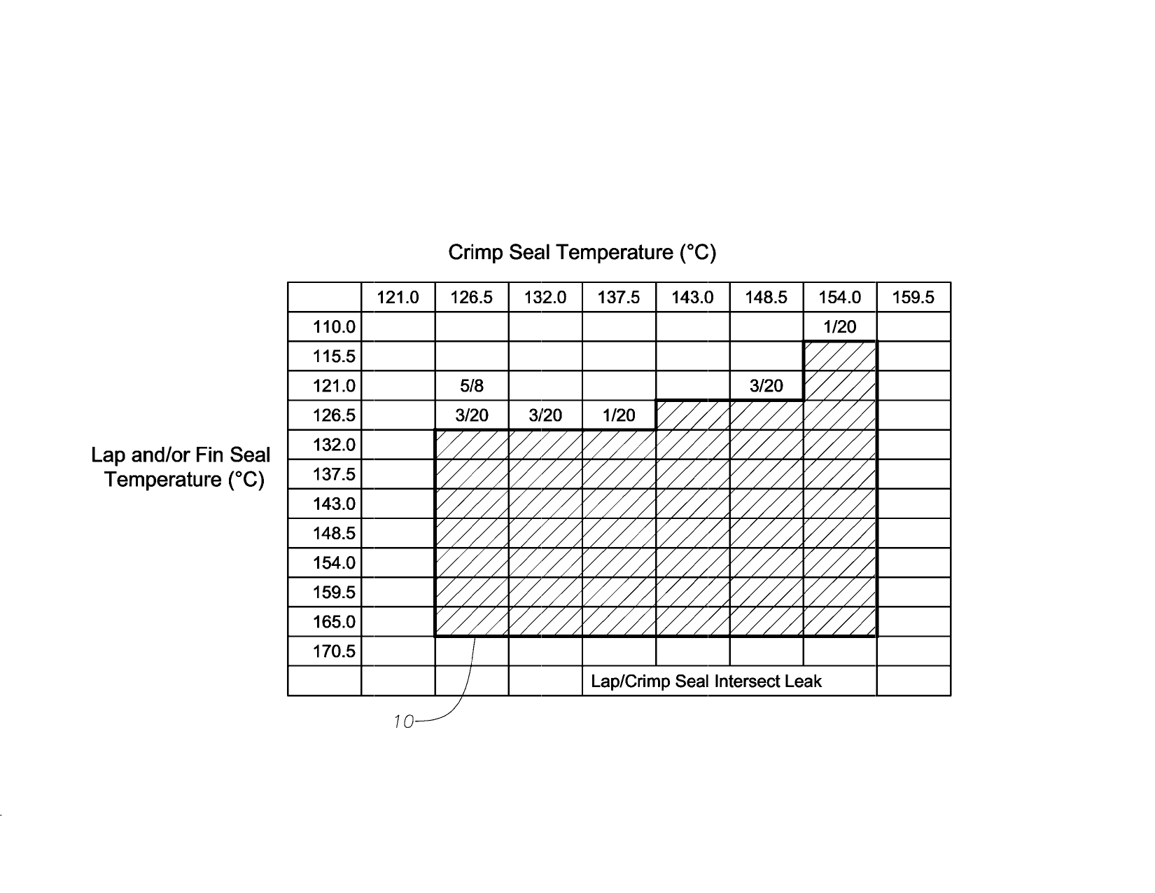

TABLE 2

| | | Lako | Hayssen | Hayssen | | Fuji | |
|---|---|---|---|---|---|---|---|
| | | ulti- | VFFS | VFFS | Fuji | HFFS | |
| | | mate | seal and | ultimate | HFFS | ultimate | |
| Ex- | Lako | seal | hot tack | seal | seal | seal | Hermeticity |
| am- | MST | (g/ | range | strength | range | strength | (# boxes) |
| ple | (C.) | cm) | (C.) | (g/cm) | (C. | (g/cm) | See FIG. 1 |
| 10 | 91 | 325 | 38 | 442 | 38 | 314 | 0 |
| 11 | 72 | 636 | 54 | 1,104 | 49 | 1062 | 48 |
| 12 | ** | ** | ** | 1,104 | ** | ** | 23 |
| 13 | 77 | 816 | 54 | 1,078 | 54 | >1,200* | 23 |
| 14 | 82 | 551 | 49 | 476 | 43 | 632 | 46 |
| 15 | 80 | 673 | 49 | 744 | 43 | 824 | 50 |
| 16 | 83 | 578 | 43 | 792 | 38 | 982 | 46 |
| 17 | 77 | 642 | 49 | 854 | 54 | 814 | 28 |
| 18 | 87 | 751 | 43 | 1,004 | 38 | >1,200* | >67* |

*>means seal strengths exceeded the measuring capability of the test equipment.
** Not tested

As we have demonstrated and as illustrated in FIG. 1, in addition to the improvements shown in Examples 2 to 9, the 18μ structures in this invention have dramatically improved hermeticity characteristics versus Comparative Example 10.

The present invention is described herein with reference to embodiments of multi-layer films, including a tie layer containing polymer blends comprising a first polymer, however, various other film structures are contemplated. Those skilled in the art will appreciate that numerous modifications to these embodiments may be made without departing from the scope of our invention. For example, while certain film layers are exemplified as being comprised of specific polymer blends and additives, along with certain arrangement of layers within the film, other compositions and arrangements are also contemplated. Additionally, while packaging is discussed as among the uses for embodiments of our inventive films, other uses, such as labeling and printing, are also contemplated.

To the extent that this description is specific, it is solely for the purpose of illustrating certain embodiments of the invention and should not be taken as limiting the present inventive concepts to these specific embodiments. Therefore, the spirit and scope of the appended claims should not be limited to the description of the embodiments contained herein.

1. A multi-layer film, comprising:
a) a core layer;
b) a tie layer, said tie layer having at least 10 wt % of a first polymer comprising from about 75 wt % to about 96 wt % propylene and from about 4 wt % to about 25 wt % ethylene, said first polymer having a density in the range of 0.850 g/cm³ to 0.900 g/cm³; and
c) a skin layer,
said tie layer being intermediate said core layer and said skin layer.

2. The film of claim 1, wherein the core layer comprises at least one polymer selected from the group consisting of propylene polymer, ethylene polymer, isotactic polypropylene (iPP), high crystallinity polypropylene (HCPP), ethylene-propylene (EP) copolymers, and combinations thereof.

3. The film of claim 1, wherein said core layer is substantially free of said first polymer.

4. The film of claim 1, wherein said first polymer comprises from about 80 wt % to about 95 wt % propylene and from about 5 wt % to about 20 wt % ethylene, and said first polymer has a DSC melting point below 100° C.

5. The film of claim 1, wherein said first polymer comprises from about 84 wt % to about 94 wt % propylene and from about 6 wt % to about 16 wt % ethylene.

6. The film of claim 1, wherein said first polymer comprises from about 85 wt % to about 92 wt % propylene and from about 8 wt % to about 15 wt % ethylene.

7. The film of claim 1, wherein said core layer substantially comprises isotactic polypropylene.

8. The film of claim 1, wherein said first polymer has a molecular weight distribution less than or equal to 3.2.

9. The film of claim 1, wherein said first polymer is produced using a substantially single site catalyst.

10. The film of claim 9, wherein said single site catalyst incorporates hafnium.

11. The film of claim 1, wherein said first polymer has a flexural modulus in the range of 20 MPa to 700 MPa.

12. The film of claim 1, wherein said first polymer has an elongation of at least 400%.

13. The film of claim 1, wherein said first polymer has an elongation of at least 500%.

14. The film of claim 1, wherein said first polymer has an elongation of at least 1000%.

15. The film of claim 1, wherein said first polymer has a substantially isotactic stereoregular propylene crystallinity.

16. The film of claim 1, wherein the core, tie-layer, or both further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof.

17. A package, comprising the multi-layer film of claim 1.

18. The package of claim 17, wherein said package is a pouch.

19. The package of claim 17, wherein said package is sealed by contacting said skin layer to itself and using a crimp sealer to seal said package and wherein said seal has seal strength greater than 700 g/cm for a VFFS seal formed on a crimp sealer as measured according to methods described herein.

20. The package of claim 17, wherein said package is sealed by contacting said skin layer to itself and using a crimp sealer to seal said package and wherein said seal has seal strength greater than 600 g/cm for a HFFS seal formed on a crimp sealer as measured according to methods described herein.
